(19) United States
(12) Patent Application Publication
(10) Pub. No.: US 2018/0085268 A1
(43) Pub. Date: Mar. 29, 2018

(54) Flexible lifting and lowering system

(71) Applicant: Christopher Mark North, Ash Fork, AZ (US)

(72) Inventor: Christopher Mark North, Ash Fork, AZ (US)

(21) Appl. No.: 15/330,493

(22) Filed: Sep. 29, 2016

(51) Int. Cl. A61G 7/10; A61G 7/00

(52) U.S. Cl. CPC A61G 7/1011; A61G 7/1021; A61G 7/0005

(57) ABSTRACT

A way of safely lifting or lowering a person of limited physical strength or coordination, using a system of bladders an outer membrane and a supply of product, gas, liquid or otherwise.

By using a small portable lifting or lowering device, comprising of a series of bladders with fail safes encased in an outer membrane, peace of mind and mobility can be given to people of limited physical strength. The fear of falling and not being rescued can cause people to move into a different assisted living home. With this system of lifting, the fear of falling would be greatly reduced.

### CROSS REFERENCED TO RELATED ARTICLES

Provisional patent application No. 62/284,699

### FEDERALLY SPONSORED RESEARCH

Not applicable

### SEQUENCE LISTING

Not applicable.

### BACKGROUND

A person with limited mobility falling and not being able to get back up again faces a number of challenges. Ideally a relative or friend is nearby to help them back up. If this is not the case options start being reduced markedly. An elderly person, for example might lack the strength to lift a spouse up from the floor. Lifting a person from a floor is difficult and without proper training or care, can cause injuries to both parties.

Emergency Medical Technicians are trained in various ways to lift people. In the best case scenario, they will arrive at a house, enter the house and lift the person up. This causes a great deal of embarrassment for the person being lifted. The worst case scenario can quickly escalate.

People in medical establishments, nursing homes, hospitals etc require moving or they may fall. The fear of falling will prevent people from wanting to go anywhere, or do anything.

In either of these cases a suitable method of lifting people should be employed.

The staff at these establishments have to be trained to lift and to rely on large and cumbersome lifting devices. Nurses are not allowed to physically lift patients due to fear of injuries.

These devices are either physically attached to walls of ceiling, such as bath lifts or sling lifts. Or they are mobile A frame devices and chair lifts.

A device that is physically attached to a roof or a wall obviously cannot be used elsewhere. These devices are very expensive (ranging from 2-15,000 dollars) and require professional installation. Most of them work with the aid of putting a person in to a sling type arrangement which is both degrading and difficult. They also have a limited range of motions.

These devices are not affordable to an average household, they require specialized training to be able to operate, they are not designed for the actual person requiring the lifting to operate and are large and bulky systems. Additionally, they are very ‘industrial’ looking and serve as a constant remainder to the person needing them that they are not as physically active as they may wish they would be.

Although hospitals have backup power systems, the fear of a power outage while the device is in operation is very real. It may only strand the patient for a few seconds, but this would be enough to cause a dislike for the device, the next time it is required.

A frame lifts differ slightly,

These again are designed such that a person would be placed in a sling to be lifted. Because of the height of the device and the requirements of the sling, they too have a limited range of mobility, they cannot be used from a flat floor.

Getting a person into the sling depends on that person being able to move properly, if they are unconscious or not able to perform certain functions, putting the sling on would be extremely difficult. In addition, it takes a lot of time, and it effects the dignity of the person being lifted.

A frame lifts are bulky contraptions, they would have to be stored in a certain area, and because of the fact they are carrying precious ‘cargo’ they have to be engineered to instill a level of confidence in the user.

A frame lifts, as well as the fixed position lifts are designed for nursing home or hospital type environments and are not designed to be used in a private house, even if the expense can be overcome.

They again, cannot be controlled by the person who is actually requiring the lifting and they cannot fit in many areas due to their design. If a person were to fall in a stairwell for example, an A frame lift would not be able to reach them.

Chair lifts also suffer all the same issues as listed above. Chair lifts are usually smaller than A frame lifts but they do have to be designed to be as stable as possible, which means they have a wide footprint. This wide footprint is essential in lifting a person safely but means that the areas such lifts can get into is more limited. These types of lift range in price from 2-6 thousand dollars, again out of the reach of many private individuals.

The final type of lift is currently being sold by the ELK company, called a Camel lift this also has several disadvantages. It is expensive, currently around $3500 and is designed to be operated close to an electrical supply. It is again very bulky almost the size of a bed, which limits the places it can be used. Again it is not designed to be operated by the person requiring the actual lifting.

### ADVANTAGES

The device for which I am applying for is much cheaper to build. It is not made from welded steel rather from fabric and tubing. This makes it cheaper to sell and therefore increases the number of private individuals that can afford it. Putting a person onto the lift would be a much simpler due to the person being able to shuffle or roll on to a flat envelope.

The device is much more portable. Most embodiments of the device would not weigh more than 5-15 pounds. It can therefore easily be carried in a wheelchair, making it immediately available to a person of limited mobility should they require it. In its construction for lifting people, the device is at least half the size of any other type of lift.

The same device can be used to lift objects and in this configuration sizing would depend on the object being lifted.

The device could be carried in ‘crash kits’ portable first aid kits and deployed immediately rather than having to go to collect an A frame type lift, wheel it in to place, operate it, and then return the lift to its storage area. This is assuming that the facility that the person has fallen in, actually has a lift.

The device does not need the room to be laid out in a certain way because it would not need to be wheeled into position.

The device can be used in a private home working around all the furniture and other obstructions currently in place.

The device can also act as a lowering device, using various design features the device can be run ‘in reverse’ and therefore act as a controlled lowering system. This would be advantageous for example in transferring a person from a wheelchair into a swimming pool.

The device is not always ‘on display’ as a constant remainder to the person needing it that they have limited mobility. You are not going to be always staring at a big beige metal contraption.

The device is safer; it has multiple fail safes built in to its mode of operation.

The device can handle a very large range of loads.

The device can be operated by the person requiring the lift themselves, it does not absolutely require an assistant, though depending on the range of mobility of the person requiring the lift this may be beneficial.

In many embodiments the device does not require external or indeed any electrical power.

### SUMMARY

The current designs of lift are expensive, bulky, take a long time to get in and out of, have a limited range of motion and are not designed to be used by the person requiring the actual lifting. They are designed for commercial facilities to operate usually in one location and consideration has to be made to allow them to reach a person, meaning the layout of the room that a person falls in, has to have consideration for the machine to come and lift them up. They have weight limitations, and are very industrial in their design. Depending on the skill of the operator, the person being lifted can also be scared of such lifts, being dropped, having a power failure or the device itself failing can frighten people into not wanting such devices being used on them. Fail safes are built in to these devices which adds to the initial cost. If the device were to fail in a bathroom for example, until that device is fixed, the entire group of people who use that bathroom would not be able to bathe.

The system I am applying for would be cheaper, making it more affordable for a private household, much more portable and would require no training to use.

The system is designed such that, if necessary, the person requiring the actual lifting would be able to control it themselves. It does not require power and can be operated from a surface that is not perfectly flat. It has a much higher weight limitation, a larger range of motion as it is designed to lift from below rather than from above. It would be faster, to operate, quieter and would not require an assistant. It is reusable and can be carried by the person who is most likely to need it, making it immediately available for the person requiring the lift.

A system has also been developed for one person to be able to have the device brought to them, rather than relying on an assistant and assuming they do not fall within reach of the device. The specifics of this are beyond the scope of this application.

### DISCUSSION OF THE PRIOR ART

U.S. Pat. No. 61,136,188 stewart, et al, works in a different design, their device is limited to one bladder and the addition of springs and pulleys makes the device much more complex. The device still requires a power supply and a controlling unit.

U.S. Pat. No. 4,629,162 Porche, is an inflatable bladder of one particular shape. This system relies on the addition of a bathtub in order to lift a person into and out of a bath. The device requires power and a remotely operated blower attachment. The device is only to be used in a bathing environment.

U.S. Pat. No. 3,990,681 Mckeen, is a tire pressure lifting device. This is a ramp shaped lifting device for vehicles. It is designed with a double bladder system and relies on the different properties of a fluid filled chamber and a pneumatic chamber, in order to stabilize a vehicle. It is not designed to lift, but rather to support a tire.

U.S. Pat. No. 3,822,861 Scott, is a pneumatic powered bag designed to remove concrete forms. This is designed to push against a form, has a very limited range of motion an is not designed to be used as a lift, but rather a wedge, giving mechanical advantage.

U.S. Pat. No. 3,346,885, Merriman is again a bath tub lift, with a hand pump it is a single bladder. This device is physically pumped by aid of a hand pump and is not designed to lift from outside a bath.

U.S. Pat. No. 266,449 Champagne et al, is a device that is worn like a corset and inflated to provide pressure to internal organs. It is not designed to lift in any way.

U.S. Pat. No. 4,538,854 Wilson, this is a chair with a built in bladder, designed to assist the elderly in getting up out of the chair with less effort. The device cannot be used from a flat floor, it is merely an inflatable cushion to help a person stand up easier.

U.S. Pat. No. 4,592,581 Hellwig, This is again an inflatable cushion designed to assist in posture control. It is not designed to lift.

U.S. Pat. No. 4,905,329 Heilner. This is an inflatable cushion of ring shaped design, to assist in lifting a person up from a sitting position in a chair to a stand position.

U.S. Pat. No. 4,993,736 Garman is a wheelchair lift this is an adjustable cushion and is not designed to lift a person who is on a floor, but rather to adjust their height while they are seated in a wheelchair.

U.S. Pat. No. 5,361,433 Vanzant is an adjustable lifting device used to assist physically handicapped people in rising from and lowering into a seated position. It is not designed to lift from a flat floor, rather it is designed to give a person a boost, to get out of a chair.

U.S. Pat. No. 5,398,994 Thomas is a adjustable lifting device designed to lift a passenger in a vehicle a couple of inches, and then to rotate that passenger, allowing easier egress from and access to a passenger vehicle.

The reader can ascertain, the prior art is concentrated on lifting a person from a chair to a standing position, none of the prior art is designed to lift a patient from a flat floor to a sitting position. The fact this device does not rely on the physical strength of any person, means that the person being lifted does not even have to be conscious.

### DRAWING

FIG. 1, This view is used to demonstrate one of the embodiments of this system. It can be seen the pods (3) are placed on either side of the envelope (1). This embodiment has a rigid surface on the upper portion of the envelope used for structural stability (17). Tubing (4) is shown externally for illustrative purposes, though this is optional to make this internal or external in the final version. In this view the envelope is fully inflated to its maximum height.

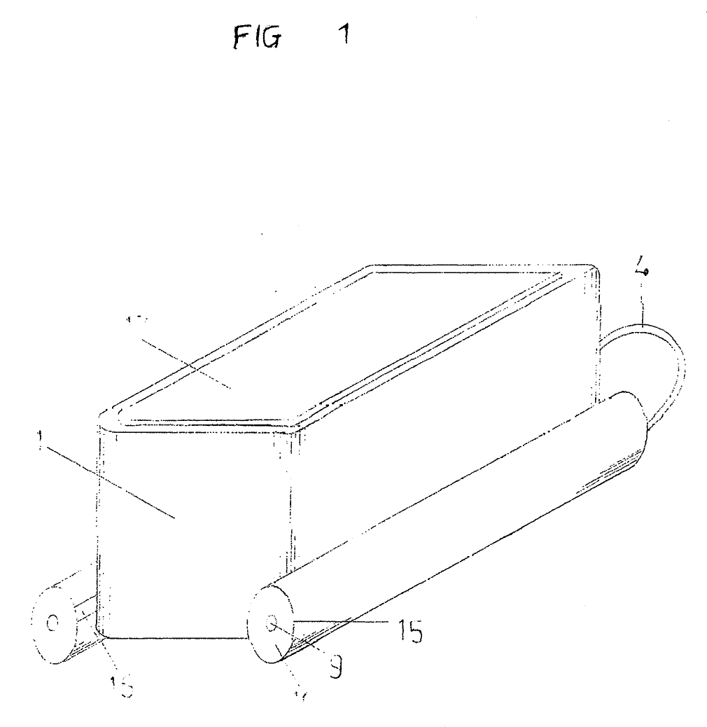

FIG. 2, This view is to demonstrate the mode of action of the system. The end view of the envelope (1) is shown with its movement included. Starting off in a flat deflated state, the device is activated and inflates in a controlled way to its full height. This view also shows the inclusion of a rigid structure on the uppermost side of the envelope (1) which can be used to and in structural stability or can be used to provide thermal insulation against the exothermic reaction the generation of foam will create, if using the foam powered variant. In this view the pods (3) are attached via hook and loop fasteners (16) to the exterior of the envelope (1). The pods (3) are covered with cloth or fabric (15) and this encases foam or padding (10) to prevent a user being able to injure themselves or damage the internals of the pod (3). The system is activated with the controller (9) that will, depending on the variant be a valve to release compressed gas or a switch to turn on the motor power the fan compressing atmospheric air, or a switch to initiate the generation of foam.

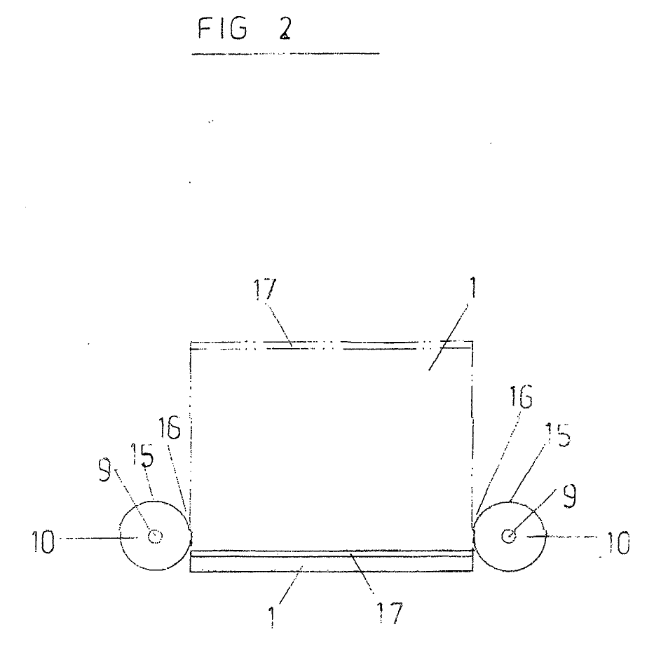

FIG. 3, This is an internal view of the envelope (1) showing one possible orientation of the bladders (2) Again, the pod (3) is placed on either side of the envelope (1) and attached via hook and loop fasteners (16). The tubing (4) is not included in this view.

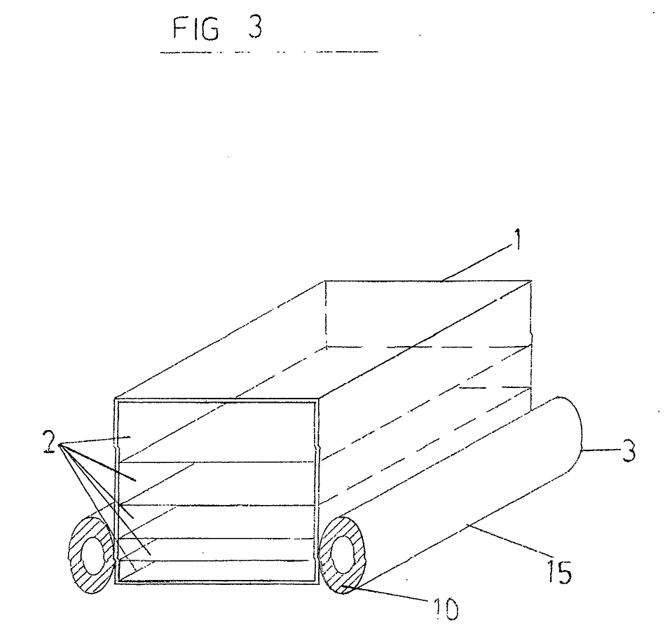

FIG. 4, This is a closer up view of the internal structure and connections between the pods (3) and the envelope (1). In this view can be seen the pod (3) covered with cloth (15) and attached to the exterior of said envelope (1) by hook and loop fasteners (16). This view also shows one of the possible ways of orientating the bladders (2) and the connections made with the tubing (4). The interface of the tubing (4) and the bladders (2) is made with the use of a valve (5). Each bladder (2) is connected to its own supply tubing (4) through its own valve (5) in order to function if one of the bladders (2) were to fail.

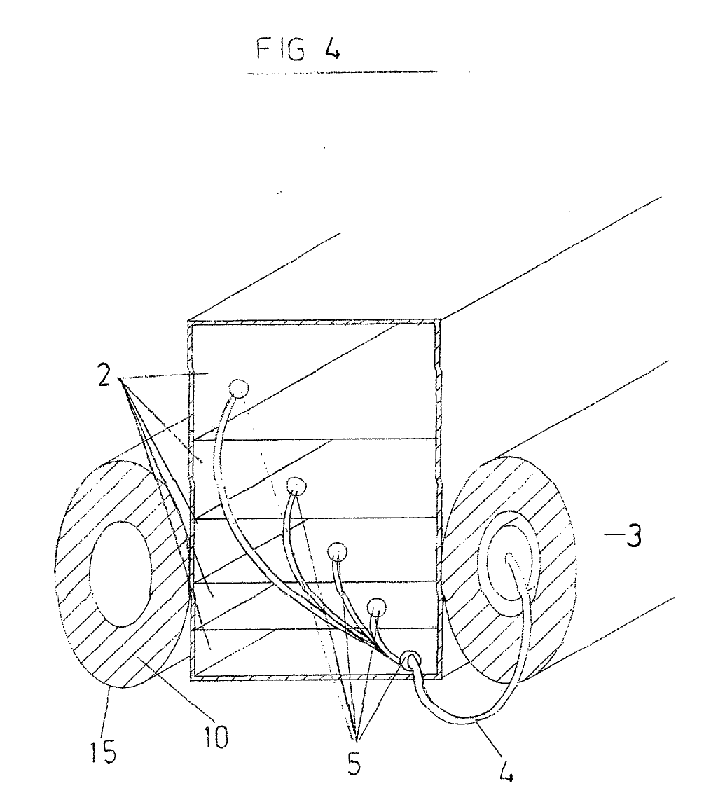

FIG. 5. This is a plan view of a potential internal orientation of the bladders (2) inside said envelope 91). In this view can be seen tubing (4) coming from a pod (3) through valves (5) to each bladder (2).

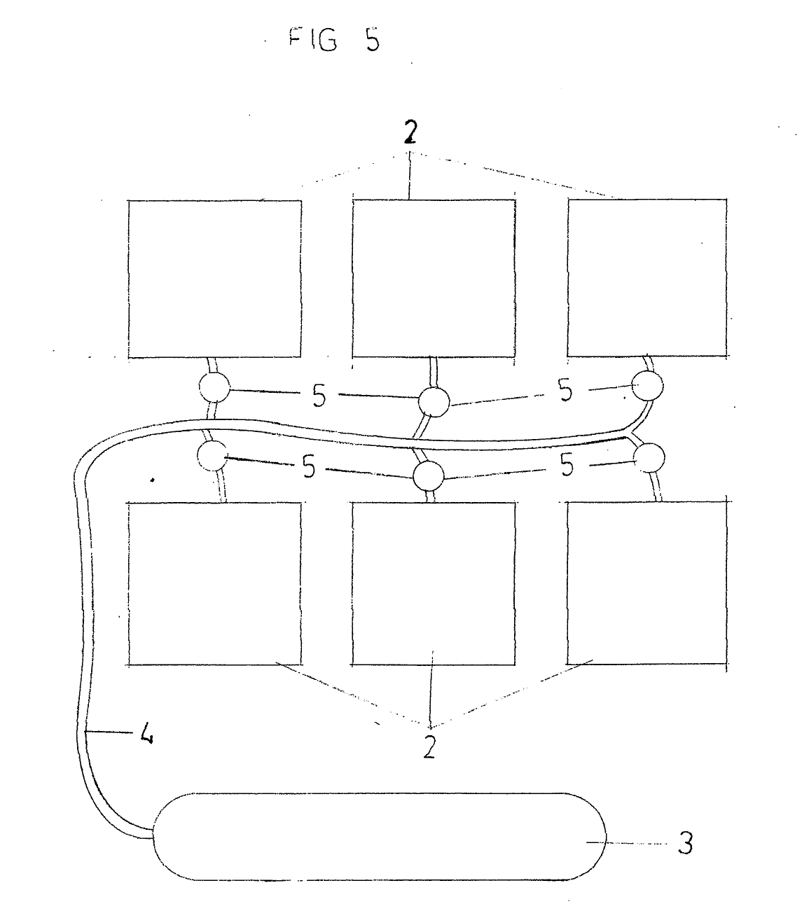

FIG. 6. This is a plan view of one of the possible arrangements of said bladders (2) being placed inside said envelope (1) being supplied from said pod (3) through said tubing (4) utilizing said valves (5).

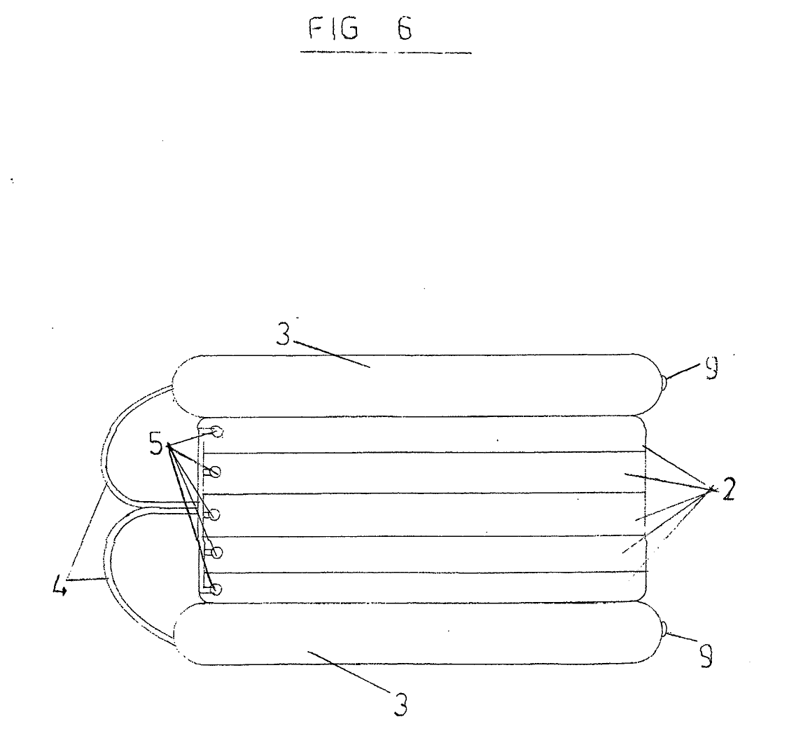

FIG. 7. This is a close up view of the end of the one of the pods (3) and its attachment to said envelope (1) with hook and loop fasteners (16). At the end of pod (3) can be seen the controller (9). The Controller can be a number of different systems. The simplest system would be with the compressed gas powered variant, said controller can be as simple as a gas valve to regulate the flow of compressed gas housed inside the pod (3) into said bladders (2). In the foam powered variant the controller would be a switch that would initiate the mixing of the different foam generating chemicals and their introduction.

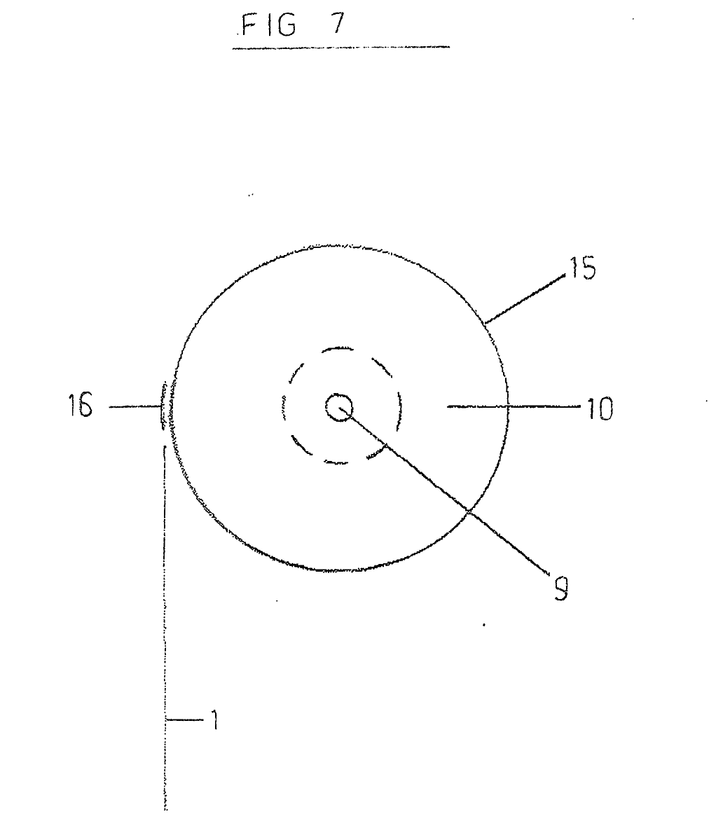

FIG. 8. is a cut away view of the internal structure of the fan powered variant of the pod (3) This view shows the controller (9) at one end. In this embodiment the controller would be a simple switch. This variant is shown utilizing batter power from a battery bank (8) to drive a motor (7) connected to a fan (6). Said fan is connected in such a way as to provide a flow of atmospheric air through said tubing (4) and on into the system. The internals of the pod are encased in soft and flexible foam (10) and the exterior of the pod is covered with fabric (15).

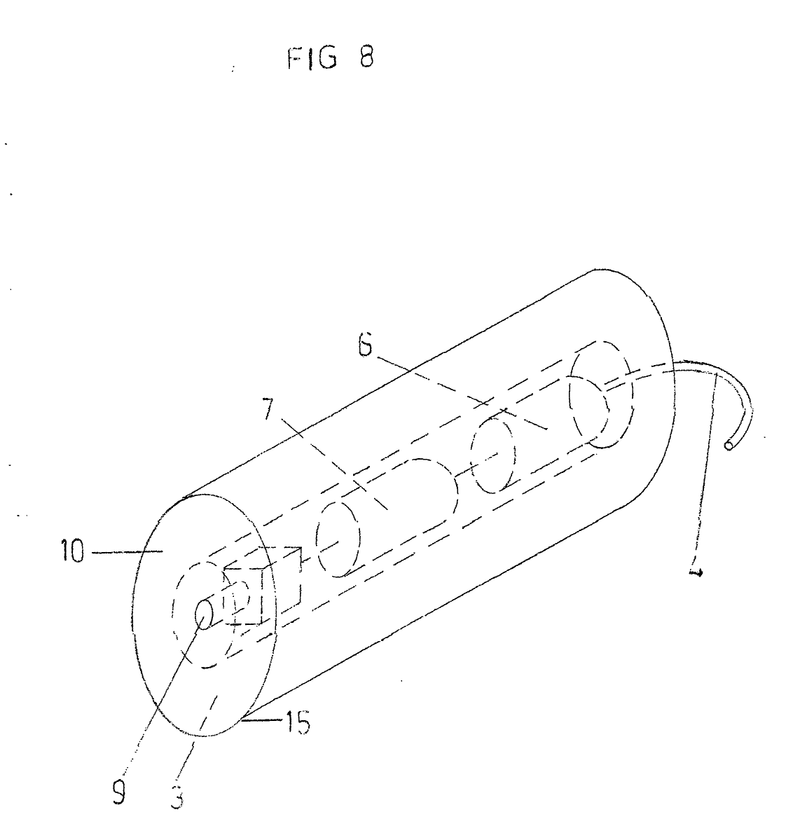

FIG. 9, This view is again a cut away illustration showing the internals of the foam powered variant of the system. The pod (3) is again encased in fabric material (15). The internals of the pod are encased in soft foam (10) to avoid injury to the patient or casualty. Chemicals used to create foam are currently in 2 or 3 liquid states and react under presence of a catalyst to form foam. In this embodiment vessels 11, 12 and 13 are storage containers for the liquids and catalyst. The method of which these liquids are forced out of said storage vessels through tubing (4) and into said bladders (2) is through the use of the device 14. This device will be a small gas canister which will be of sufficient volume and pressure to force said liquids together mixing with the presence of said catalyst and be directed into said tubing (4) to be able to react inside a single large bladders (2) This embodiment will have one bladder encapsulated with the outer envelope (1) as the concern of one of the bladders failing is mitigated due to the form being self sealing.

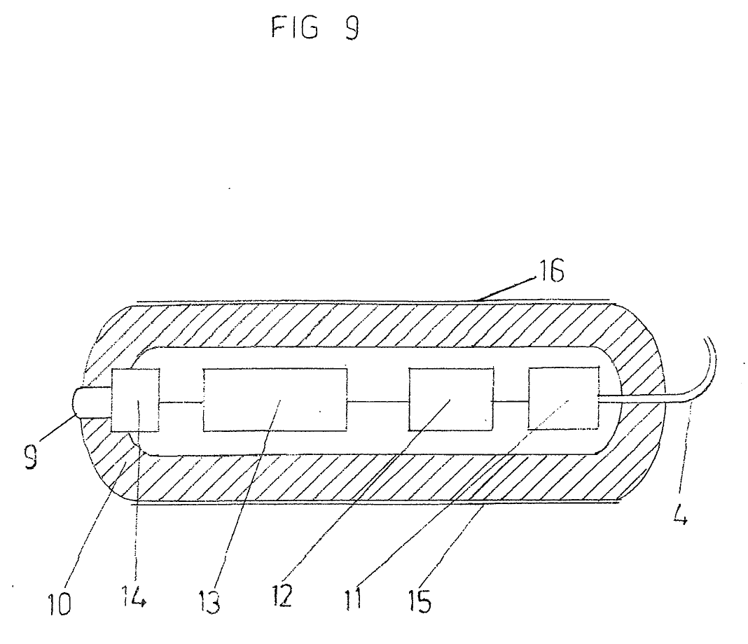

FIG. 10. This shows one of the possible variations in regards to the orientation of the pod (3) and the shape of the envelope (1). In this particular view the tubing (4) is internal to the envelope (1).

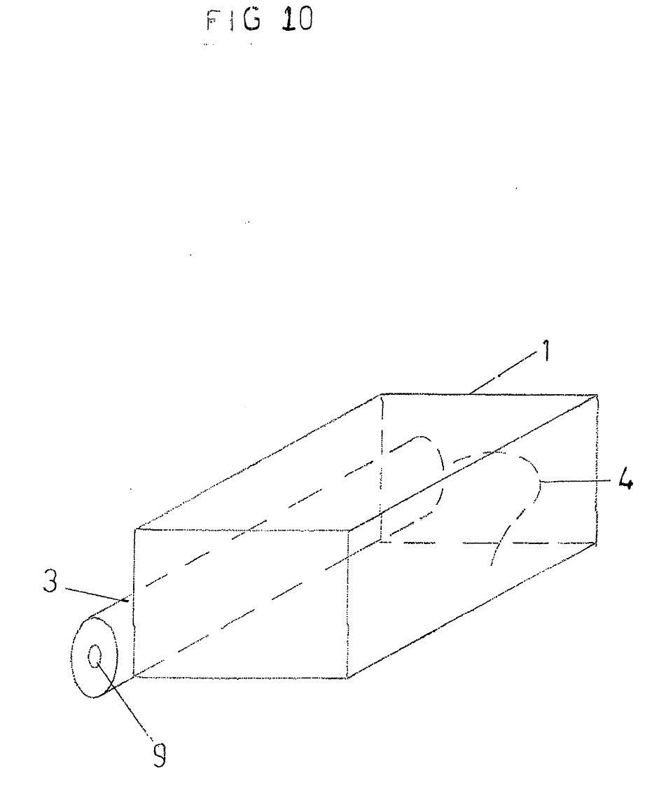

FIG. 11. This view shows possible shape differences of the outer envelope (1) and their relation to the pods, illustrating that the shape of the outer envelope can be altered should different spaces of construction requirements be taken into account.

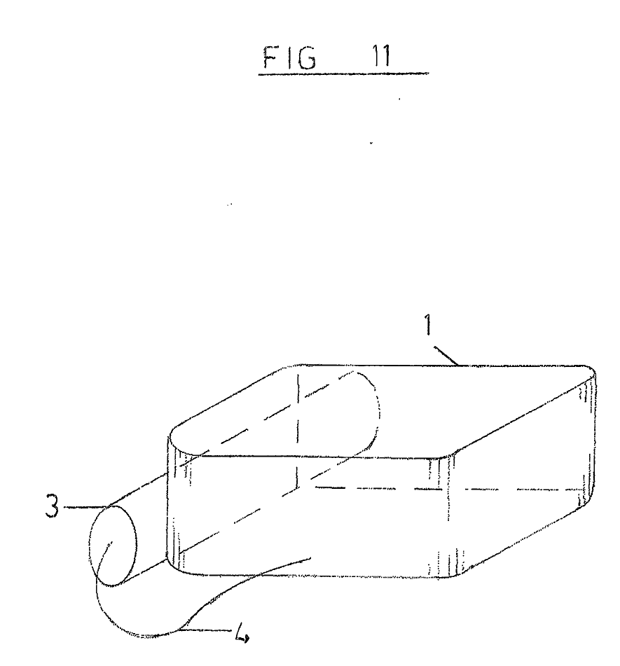

FIG. 12. This view shows a different design of the outer envelope (1) as can be seen in the application the outer envelope can come in a plurality of different shapes and should not be construed as just one shape. This outer envelope is a cylinder shape, the rest of the elements are adjusted accordingly to fit the outer envelope shape.

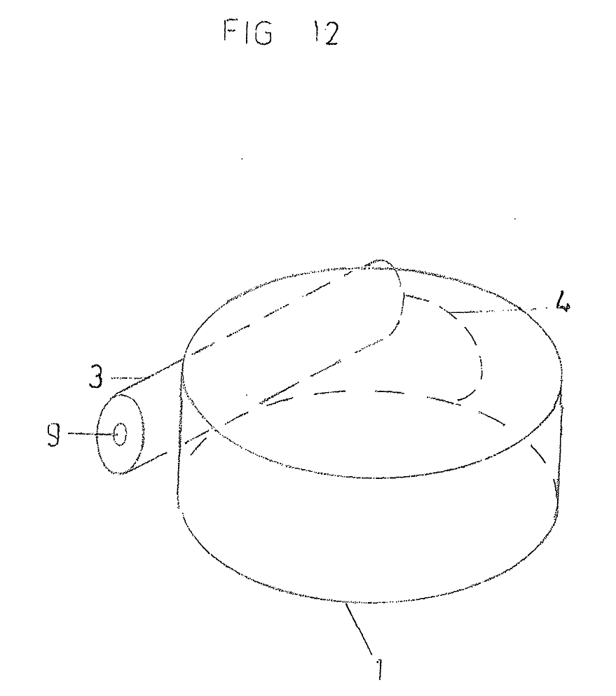

FIG. 13. This view shows another different design of the outer envelope (1) The same elements are in the same configuration as the previous explanations but the outer envelope shape has changed to a flat topped pyramid.

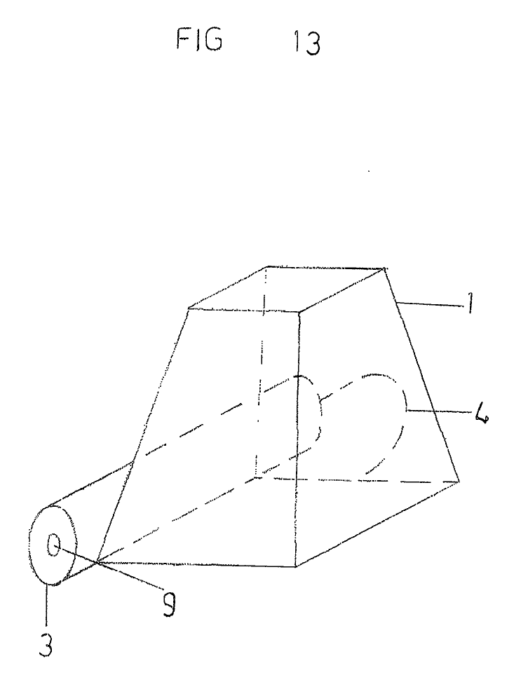

### DETAILED DESCRIPTION, FIRST EMBODIMENT

The device will consist of a flexible envelope. Made of a rubber of vinyl or a similar material various different shapes can be made, but for the sake of clarity a cube will be described. This does not in any way limit the design to a cube, many other shapes can also work just as well therefore the reader is to not assume only one shape will be in any way preferable than any other. Nor is the reader to assume any particular materiel is preferable over any others.

With a cube, the device will consist of an outer membrane. A square base attached on the edges to another square sheet of materiel. This will be repeated until a cube is formed. The device will be designed to operate in one orientation and this will be clearly marked, for example by being a different color.

Inside the cube will be a series of smaller bladders, designed to hold gasses, in this embodiment, under pressure. If the device is a cube, the bladders will be sufficient in size and number to cover the footprint of the cube. The number and design of said bladders is not limited, a plurality of designs would be possible.

Said bladders.will be fitted with a tubing system, sufficient to allow a flow of gas from a reservoir into said bladders. Said reservoir can be internal or external to the outer membrane. In this example it is outside the membrane and would be a compressed gas bottle. The gas bottle would be encased in one of the pods that are attached to the sides of the cube with hook and loop type fasteners.

At various points in said tubing a valve sufficient to block the flow of gas will be placed which will be a variable one-way valve system, preventing a flow of gas into said bladder, should said bladder be compromised. With the incorporation of a type of valve that would act as a one way valve while filling, then with the removal of a flow of electricity move to act as a standard valve, the device can be used both as a lowering device, in the opposite manner described above, or reset the device such that it can be packed away again and ready for the next use.

An additional safety feature will be that the bladders are of sufficient, size, such that if one were to fail, the workload of that failed bladder could be accommodated by the surrounding bladders

By introducing compressed air through said tubing and through said valves into said bladders, this will cause the bladders to expand in size. They can start off as a flat envelope and expand in stages. The bladders will be fitted with a pressure valve in order to allow the inflation of the bladders to be in stages. This has a number of distinct advantages.

Firstly, it allows bladders of certain shapes to be incorporated in the design, by allowing these bladders to be inflated first they can create, armrests or other such shapes in order to improve the feeling of safety of the person being lifted.

Secondly with one bladder being inflated fully before the next, this creates an additional feeling of stability. The bladder is not very stable WHILE it is being inflated but after it is very stable. This inflation in stages again helps the person being lifted feel more secure.

The pods shown in some of the drawings are useful in various different ways, they initially are used as a means of placing the reservoir near the device without having to see a compressed gas bottle, or the workings of a motor. They are an optional part of the system and all the different methods of filling the bladders can be switched out, without changing the actual outer membrane or bladders internal to that membrane. An additional use of the pods is that the increase the surface area of the outer membrane in its flattened state, this is useful because until the first bladder is filled to pressure as it increases the feeling of stability to the user.

### Description Alternative Embodiment

A device similar in design to the first embodiment but instead of a compressed gas cylinder providing pressure, an electrical fan, would be employed. This would mean that the device would have access to a power supply, but would function in a very similar way. The electricity supply could be from the grid, the device could be plugged into the wall, or from internal rechargeable batteries.

### Description of Alternative Embodiment

A device similar in design to that listed above. The inflation would be performed in a different way; chemical components could be introduced to the bladders that would create foam. Currently poly urethane foam creates toxic byproducts, but if different foam making chemicals were developed, the device could inflate chemically. Currently technology means that the creation of foam is an exothermic reaction, therefore a design consideration has to be me to protect the patient from this generation of heat, by having an insulation layer between the outer membrane and the interior of the bladders.

This also raises an additional use of the product that of temporary furniture.

The outer membrane could be made into almost any shape, a chair for example. The membrane could be deflated for shipping, inflated in situ and then filled with foam chemicals in their liquid state. Using different foam making chemicals (which can vary in density) we can separate each bladder by function and fill each one as determined by the function it will be required to perform. I have not provided the chemical components for this foam as currently the preferred method of creating foam, releases chemicals which are toxic, thereby currently making this a dangerous procedure.

### Description of Alternative Embodiment

Currently the discussion has focused on a cube, different shapes would present different advantages or possibilities. A cylinder for example would potentially require less material to make, a pyramid would afford a larger base surface area meaning more stability.

The arrangement of the bladders could also be altered, the idea of one rectangular bladder being filled should not be construed as a limitation, if a bladder were encased in another bladder then less product would be required to fill the second bladder for example.

### Description of Alternative Embodiment

Many other types of filling material can be suggested for the bladders. Liquids, gasses, powders etc, these could all be introduced by chemical means. A plurality of other means of causing the outer membrane to raise, or lower could be employed. A combination of these delivery methods could also be employed, gases to raise the device can be produced from many different chemical reactions.

### Description of Alternative Embodiment

A version of the device could be developed that would purposely not hold pressure for a period of time. The reason behind this is that the device could inflate as mentioned in other embodiments and as long as a supply of gas or liquid is in progress, the device would stay inflated. If the supply of gas or liquid were stopped, the device would slowly deflate. This would negate the requirement for having valves due to the fact that the device would be in its un-inflated state at all times. It would also be possible to have the device as a lowering system, by controlling the rate of product being put in, if this rate were lower than the leakage rate, the device would deflate controllably.

### Conclusion Ramifications and Scope

Thus the reader will be able to see that the device is smaller, lighter, more portable, quieter, and more practical than the previous attempts at solving this problem. With the fact the device is designed to lift from underneath the patient rather than from on top, it has a larger range of motion than A frame lifts.

With the fact that the device will work on almost surface, does not require training and is highly intuitive to use it can be made from many different colors of or types of materiel and designs. Several different embodiments in the mode of action can be employed by the same unit making the ability to switch from compressed air to liquid to chemical, this makes the unit more flexible than tying the system to just one method.

The pods are optional; they provide a means of switching the inflation method without changing the entire system. The fact that an electrical apparatus can perform the same task as a gas powered variant provides peace of mind to the user, in the event one system fails.

The device also has a larger weight carrying capacity therefore making it ideal for loading of cargo and not just limited to people.

Accordingly, the reader will see that, according to one embodiment of the invention, I have provided the system differs from any currently available design. It recognizes a need for a cheaper, more reliable effective and safe lifting device. While the above description contains many specificities, these should not be construed as limitations on the scope of any embodiment, but as exemplifications or various embodiments thereof. Many other ramifications and variations are possible within the teaching of the various embodiments. For example, the shape of the device could be a triangle, or a pyramid or a circle. Thus the scope should be determined by the appended claims and their legal equivalents, and not by the examples given.

### Sequence Listing

Not applicable.

A: A flexible lifting system comprising of an outer membrane with a plurality of sides a top and a base.

B: A flexible lowering system comprising of a plurality of sides top and base as in claim A.
Comprising of all of claim A, tubing, the tubing will connect a series of internal bladders. Said tubing will be connected from a method of filling to a series of bladders. Said tubing will have in various positions along it's length valves.

A2.1 Said bladders will be designed such that they are able to change shape inside the outer membrane. They must be able to expand in shape.

A2.2 Said bladders will be configured such that if one or more fail in their operation, due to bursting or any other issue, then said remaining bladders will have sufficient materiel to expand in to the vacant space left by the unusable bladder.

A2.3 Said bladders must be designed such that they are able to contract in volume by opening of release valves.

B: B1.1 Said valves will be placed in locations between said bladders and said method of filling. Said valves will be used to allow or restrict flow of materiel from said reservoir to said bladders.

B1.2 Said valves will be controlled through a system of opening and closing, to allow access or egress of product from said reservoir to said bladder.

C1. Gas canister of sufficient compressed volume will be attached to said tubing sufficient to allow a flow of gas in said canister through said tubing into said bladder.

C1.1 A method of filling using a gas canister and a re-breather to enable filling of said bladders more rapidly and with less compressed gas than claim Cl.

C2 An electric pump powered by batteries or by electrical power from the grid can be used to create a flow of compressed atmospheric air through a fan system through said tubing into said bladders.

C3, Chemical reactants. Liquids transferred under pressure from said reservoir through said tubing and into said bladders could be catalyzed to convert into foam. I have omitted the chemical reactants in this application as using the current technology available this creates a quantity of toxic gas.

C4 Liquids injected through said tubing into said bladders could with enough pressure be used to lift or lower an object. This way the device could be used as a bath lift for example.
